(19) United States
(12) Patent Application Publication
(10) Pub. No.: US 2025/0125627 A1
(43) Pub. Date: Apr. 17, 2025

(54) ENERGY MANAGEMENT SYSTEMS

(71) Applicant: Enphase Energy, Inc., Petaluma, CA (US)

(72) Inventor: John Scott BERDNER, Grass Valley, CA (US)

(21) Appl. No.: 18/916,038

(22) Filed: Oct. 15, 2024

Related U.S. Application Data
(60) Provisional application No. 63/544,554, filed on Oct. 17, 2023.

(51) Int. Cl. H02J 3/38; H02J 13/00

(52) U.S. Cl. CPC H02J 3/388; H02J 13/00002; H02J 2300/24

(57) ABSTRACT

A load center configured for use with an energy management system is provided herein and comprises a main panel board configured to connect to a meter that measures energy consumed by a microgrid and a microgrid interconnect device disposed on the main panel board and configured to connect/disconnect the microgrid to/from a grid.

### CROSS-REFERENCE TO RELATED APPLICATIONS

The present application claims the benefit of and priority to U.S. Provisional Application Ser. No. 63/544,554, filed on Oct. 17, 2023, the entire contents of which incorporated herein by reference.

### BACKGROUND

### 1. Field of the Disclosure

Embodiments of the present disclosure generally relate to energy management systems and, for example, to energy management systems that use panelboards with an integral microgrid interconnect device (MID) and controls.

### 2. Description of the Related Art

Energy management (e.g., solar) systems are known. For example, energy management systems can, typically, comprise one or more photovoltaics, a microinverter, a storage system, which can comprise one or more batteries and a battery management unit/system (BMU/BMS) that is configured to control operation of the one or more batteries, and a MID which can comprise a disconnect component (e.g., a contactor or the like) for physically connecting/disconnecting a microgrid to/from a utility grid.

For example, a majority of solar systems are grid tied systems which are required to shut down during a utility outage. As a result, the users of solar systems may be without power during utility outages. To provide backup power during a utility outage, users have historically installed an external transfer device which connects the facility to either the utility grid or to a secondary source, such as a backup generator. Thus, the facility is allowed to be isolated from the utility grid and provided power from the backup generator. Alternatively, users may install external equipment to disconnect the facility from the utility grid, thereby isolating the facility from the utility grid to power the facility during a utility outage.

Therefore, described herein are improved methods and apparatus that use panelboards with an integral microgrid interconnect device (MID) and controls.

### SUMMARY

In accordance with some aspects of the present disclosure, there is provided a load center configured for use with an energy management system. The load center can comprise a main panel board configured to connect to a meter that measures energy consumed by a microgrid, and a microgrid interconnect device can be disposed on the main panel board and be configured to connect or disconnect the microgrid to/from a grid.

In accordance with some aspects of the present disclosure, there is provided a microgrid. The microgrid can comprise a distributed energy resource (DER) connected to at least one of a load or an energy storage device. The distributed energy resource (DER) can comprise at least one renewable energy source (RES). A DER controller can be operably coupled to the distributed energy resource for control thereof, and a load center can be connected to the DER, the at least one of the load or the energy storage device, and the DER controller. The load center can comprise a main panel board configured to connect to a meter of the microgrid that measures energy consumed by the microgrid. A microgrid interconnect device can be disposed on the main panel board and configured to connect or disconnect the microgrid to/from a grid.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only a typical embodiment of this disclosure and are therefore not to be considered limiting of its scope, for the disclosure may admit to other equally effective embodiments.

FIG. 1 is a block diagram of a system for power conversion, in accordance with at least some embodiments of the present disclosure; and

FIG. 2 is a block diagram of a service panel comprising a MID configured for use with the system for power conversion of FIG. 1, in accordance with at least some embodiments of the present disclosure.

### DETAILED DESCRIPTION

In accordance with the present disclosure, described herein are improved panelboards that comprise an integral microgrid interconnect device (MID) and associated controls. For example, a MID can be mounted directly into a main service panel or similar sub-panel. For example, in at least some embodiments, a load center configured for use with an energy management system can comprise a main panel board that is configured to connect to a meter that measures energy consumed by a microgrid. A MID can be disposed on the main panel board and can be configured to connect/disconnect the microgrid to/from the grid. Compared to conventional MID devices, as the MID described herein is mounted to the main service panel, there is no need to collocate the MID at a service entrance, e.g., at a meter.

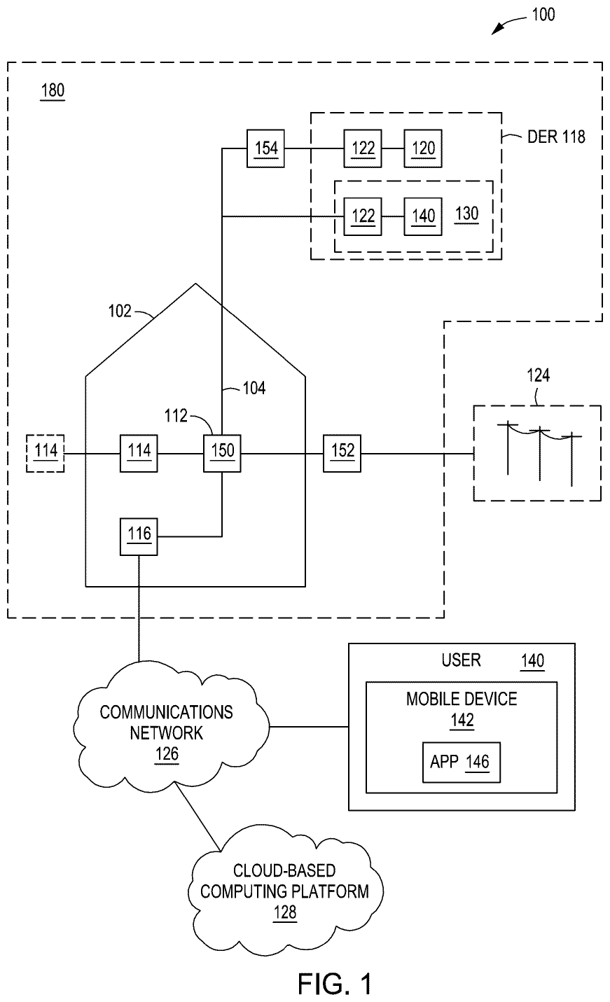

FIG. 1 is a block diagram of an energy management system (e.g., power conversion system, system 100) in accordance with one or more embodiments of the present disclosure. The diagram of FIG. 1 only portrays one variation of the myriad of possible system configurations. The present disclosure can function in a variety of environments and systems.

The system 100 comprises a structure 102 (e.g., a user's structure), such as a residential home, commercial building, or separate mounting structure, having an associated DER 118 (distributed energy resource). The DER 118 is situated external to the structure 102. For example, the DER 118 may be located on the roof of the structure 102 or can be part of a solar farm. The structure 102 comprises one or more loads 114 (and/or energy storage devices, e.g., appliances, electric hot water heaters, thermostats/detectors, boilers, electric vehicle supply equipment (EVSE), EVs, water pumps, portable energy storage, batteries, and the like, which can be located within or outside the structure 102) and a DER controller 116, each coupled to a load center 112 (e.g., main service panel). Although the one or more loads 114 (and/or energy storage devices), the DER controller 116, and the load center 112 are depicted as being located within the structure 102, one or more of these may be located external to the structure 102.

The load center 112 comprises a MID 150 (microgrid interconnect device, described in greater detail below) and is coupled to the DER 118 by an AC bus 104 and is further coupled via a meter 152 to a grid 124 (e.g., a commercial/utility power grid). The structure 102, the one or more loads 114 (and/or the energy storage devices), DER controller 116, DER 118, load center 112, generation meter 154, the meter 152, and the MID 150 are part of a microgrid 180. It should be noted that one or more additional devices not shown in FIG. 1 may be part of the microgrid 180. For example, a power meter or similar device may be coupled to the load center 112.

The DER 118 comprises at least one renewable energy source (RES) coupled to power conditioners 122. For example, the DER 118 may comprise a plurality of RESs 120 coupled to a plurality of power conditioners 122 in a one-to-one correspondence (or two-to-one). In embodiments described herein, each RES of the plurality of RESs 120 is a photovoltaic module (PV module), although in other embodiments the plurality of RESs 120 may be any type of system for generating DC power from a renewable form of energy, such as wind, hydro, and the like. The DER 118 may further comprise one or more batteries (or other types of energy storage/delivery devices) coupled to the power conditioners 122 in a one-to-one correspondence, where each pair of power conditioner 122 and a corresponding battery may be referred to as an AC battery 130.

The power conditioners 122 invert the generated DC power from the plurality of RESs 120 and/or the AC battery 141 to AC power that is grid-compliant and couple the generated AC power to the grid 124 via the load center 112. The generated AC power may be additionally or alternatively coupled via the load center 112 to the one or more loads 114 (and/or the energy storage devices). In addition, the power conditioners 122 that are coupled to the AC batteries convert AC power from the AC bus 104 to DC power for charging the AC batteries. A generation meter 154 is coupled at the output of the power conditioners 122 that are coupled to the plurality of RESs 120 in order to measure generated power.

In at least some embodiments, the power conditioners 122 may be AC-AC converters that receive AC input and convert one type of AC power to another type of AC power. Alternatively, the power conditioners 122 may be DC-DC converters that convert one type of DC power to another type of DC power. The DC-DC converters may be coupled to a main DC-AC inverter for inverting the generated DC output to an AC output.

The power conditioners 122 may communicate with one another and with the DER controller 116 using power line communication (PLC), although additionally and/or alternatively other types of wired and/or wireless communication may be used. The DER controller 116 may provide operative control of the DER 118 and/or receive data or information from the DER 118. For example, the DER controller 116 may be a gateway that receives data (e.g., alarms, messages, operating data, performance data, and the like) from the power conditioners 122. The DER controller 116 communicates the data and/or other information via the communications network 126 to a cloud-based computing platform 128, which can be configured to execute one or more application software, e.g., a grid connectivity control application, to a remote device or system such as a master controller (not shown), and the like. The DER controller 116 may also send control signals to the power conditioners 122, such as control signals generated by the DER controller 116 or received from a remote device or the cloud-based computing platform 128. The DER controller 116 may be communicably coupled to the communications network 126 via wired and/or wireless techniques. For example, the DER controller 116 may be wirelessly coupled to the communications network 126 via a commercially available router. In one or more embodiments, the DER controller 116 comprises an application-specific integrated circuit (ASIC) or microprocessor along with suitable software (e.g., a grid connectivity control application) for performing one or more of the functions described herein. For example, the DER controller 116 can include a memory (e.g., a non-transitory computer readable storage medium) having stored thereon instructions that when executed by a processor perform a method for managing an energy management system, as described in greater detail below.

The generation meter 154 (which may also be referred to as a production meter) may be any suitable energy meter that measures the energy generated by the DER 118 (e.g., by the power conditioners 122 coupled to the plurality of RESs 120). The generation meter 154 measures real power flow (kWh) and, in some embodiments, reactive power flow (KVAR). The generation meter 154 may communicate the measured values to the DER controller 116, for example using PLC, other types of wired communications, or wireless communication. Additionally, battery charge/discharge values are received through other networking protocols from the AC battery 130.

The meter 152 may be any suitable energy meter that measures the energy consumed by the microgrid 180, such as a net-metering meter, a bi-directional meter that measures energy imported from the grid 124 and well as energy exported to the grid 124, a dual meter comprising two separate meters for measuring energy ingress and egress, and the like. The meter 152 measures one or more of real power flow (kWh), reactive power flow (kVAR), grid frequency, and grid voltage. The meter 152 measures power flows independently of MID state, i.e., when the MID is closed and DER's are connected to the grid and when MID is open and DER's are isolated from the grid.

The MID 150, which may also be referred to as an island interconnect device (IID), connects/disconnects the microgrid 180 to/from the grid 124. The MID 150 comprises a disconnect component (e.g., a contactor or the like) for physically connecting/disconnecting the microgrid 180 to/from the grid 124. For example, the DER controller 116 receives information regarding the present state of the system 100 from the power conditioners 122 and also receives the energy consumption values of the microgrid 180 from the meter 152 (for example via one or more of PLC, other types of wired communication, and wireless communication). Based on the received information (inputs), the DER controller 116 determines when to go on-grid or off-grid and instructs the MID 150 accordingly. In some alternative embodiments, the MID 150 comprises an ASIC or CPU, along with suitable software (e.g., an islanding module) for determining when to disconnect from/connect to the grid 124. For example, the MID 150 may monitor the grid 124 and detect a grid fluctuation, disturbance or outage and, as a result, disconnect the microgrid 180 from the grid 124. Once disconnected from the grid 124, the microgrid 180 can continue to generate power as an intentional island without imposing safety risks, for example on any line workers that may be working on the grid 124.

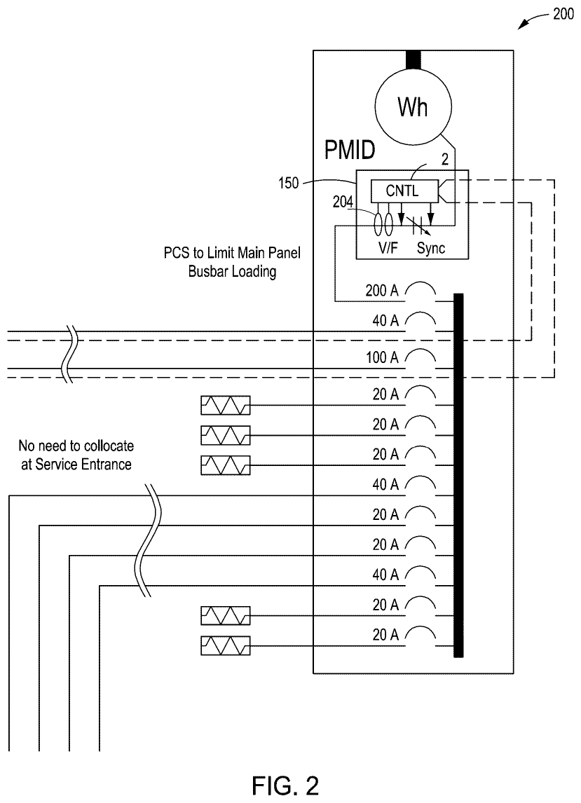

As noted above, unlike conventional microgrid interconnect devices, the MID 150 can be incorporated into a main service panel (or similar sub-panels). For example, FIG. 2 is a block diagram of a main service panel 200 (e.g., the load center 112) comprising the MID 150 configured for use with the system 100 for power conversion of FIG. 1, in accordance with at least some embodiments of the present disclosure.

The MID 150 comprises MID controls 202 and is mounted within the main service panel 200. As noted above, there is no need to collocate the MID 150 at the meter 152. The MID 150 and MID controls 202 are configured to monitor a voltage (V), frequency (F) of a grid (e.g., the grid 124), and/or current flow to the grid (e.g., via one or more sensors 204), if any. The MID 150 and MID controls 202 can also be configured to monitor the voltage, frequency and/or current flow to a facility (e.g., the structure 102). For example, the MID 150 and the MID controls 202 are configured to monitor the voltage and frequency of a power distribution system (e.g., the system 100) within the facility and autonomously isolate and safely synchronize (Sync) then reconnect the facility to the utility grid. For example, the MID 150 and the MID controls 202 are configured to autonomously isolate the facility when the grid voltage and frequency deviate from normal values (e.g., predetermined values) for periods of time specified in any utility interconnection agreements, or other applicable standards referenced by the interconnection agreements. In at least some embodiments, when connected to the utility, the MID 150 and the MID controls 202 are configured to continuously monitor current flowing between the grid and the facility.

In at least some embodiments, the MID 150 and the MID controls 202 can include self-checking mechanisms (e.g., e.g., the one or more sensors 204) to reliably detect when the facility has been isolated from the grid to prevent the backup power system from operating in off-gid mode unless the facility is isolated from the grid. For example, in such embodiments, a monitored current flowing between the grid and the facility can be one of several parameters that can be used to determine if the facility is isolated from the grid. Additionally, the monitored current flow between the grid and the facility may be used to prevent overloading of a busbars in the main service panel. Moreover, the monitored current flow between the grid and the facility may be used to economically optimize the energy use of the facility based on external variables such as the cost of utility power at any given time or other contractual agreements between the owner of the facility and the utility and/or other third-party aggregators. In at least some embodiments, the MID 150 and the MID controls 202 can isolate the facility from the grid based on, for example, external signals from the utility, a third party aggregator, or based on customer preference. When the MID 150 and the MID controls 202 isolate the facility from the utility, a PV system (e.g., the DER 118) can transition from grid-tied mode to off-grid mode to provide backup power to the facility. The backup power functionality may incorporate energy storage devices (the AC battery 130) or other backup power sources (e.g., engine generators or fuel cells).

When the grid voltage and frequency returns to normal conditions, the MID 150 and the MID controls 202 can be configured to synchronize the voltage and frequency of the backup power system to that of the grid and reconnects the facility to the grid, seamlessly with no interruption in power to the facility. In at least some embodiments, the MID 150 and the MID controls 202 can be configured to reconnect the facility to the grid with a delayed response based on external signals from the utility or based on customer preference.

The MID 150 and the MID controls 202 are configured to derive control power from one or more power sources. For example, The MID 150 and the MID controls 202 are configured to derive control power from a utility, a power distribution system within the facility, and/or from separate low voltage control power distribution wiring.

With reference again to FIG. 1, a user 140 can use one or more computing devices, such as a mobile device 142 (e.g., a smart phone, tablet, or the like) communicably coupled by wireless means to the communications network 126. The mobile device 142 has a CPU, support circuits, and memory, and has one or more applications (e.g., a grid connectivity control application (an application 146)) installed thereon for controlling the connectivity with the grid 124 as described herein. The mobile device 142 may run on commercially available operating systems, such as IOS, ANDROID, and the like.

In order to control connectivity with the grid 124, the user 140 interacts with an icon displayed on the mobile device 142, for example a grid on-off toggle control or slide, which is referred to herein as a toggle button. The toggle button may be presented on one or more status screens pertaining to the microgrid 180, such as a live status screen (not shown), for various validations, checks and alerts. The first time the user 140 interacts with the toggle button, the user 140 is taken to a consent page, such as a grid connectivity consent page, under setting and will be allowed to interact with toggle button only after he/she gives consent.

Once consent is received, the scenarios below, listed in order of priority, will be managed differently. Based on the desired action as entered by the user 140, the corresponding instructions are communicated to the DER controller 116 via the communications network 126 using any suitable protocol, such as HTTP(S), MQTT(S), WebSockets, and the like. The DER controller 116, which may store the received instructions as needed, instructs the MID 150 to connect to or disconnect from the grid 124 as appropriate.

In some alternative embodiments, a portion of the MID 150 can be part of the DER controller 116. For example, the DER controller 116 may comprise a CPU and an islanding module for monitoring the grid 124, detecting grid failures and disturbances, determining when to disconnect from/connect to the grid 124, and driving a disconnect component accordingly, where the disconnect component may be part of the DER controller 116 or, alternatively, separate from the DER controller 116. In some embodiments, the MID 150 may communicate with the DER controller 116 (e.g., using wired techniques such as power line communications, or using wireless communication) for coordinating connection/disconnection to the grid 124.

While the foregoing is directed to embodiments of the present disclosure, other and further embodiments of the disclosure may be devised without departing from the basic scope thereof, and the scope thereof is determined by the claims that follow.

1. A load center configured for use with an energy management system, comprising:
a main panel board configured to connect to a meter that measures energy consumed by a microgrid; and
a microgrid interconnect device (MID) disposed on the main panel board and configured to connect or disconnect the microgrid to/from a grid.

2. The load center of claim 1, wherein the microgrid interconnect device (MID) is configured to connect or disconnect the microgrid to/from the grid without having to collocate the microgrid interconnect device (MID) at the meter.

3. The load center of claim 1, wherein the microgrid interconnect device (MID) comprises controls and is mounted within the main panel board.

4. The load center of claim 3, wherein the controls are configured to monitor at least one of a voltage and a frequency of the grid or current flow to the grid.

5. The load center of claim 3, wherein the controls are configured to monitor at least one of a voltage and a frequency of a facility or current flow to the facility.

6. The load center of claim 3, wherein the controls are configured to autonomously isolate a facility from the grid when a grid voltage and frequency deviates from predetermined values.

7. The load center of claim 3, wherein the controls are configured to autonomously isolate a facility from the grid based on at least one of external signals from a utility, a third party aggregator, or customer preference.

8. The load center of claim 3, wherein the controls are configured to continuously monitor current flowing between the grid and a facility.

9. The load center of claim 3, wherein the controls comprise a self-checking mechanism to detect when a facility is isolated from the grid to prevent a backup power system from operating in an off-gid mode unless the facility is isolated from the grid.

10. The load center of claim 9, wherein the self-checking mechanism is a sensor configured to monitor a current flowing between the grid and the facility.

11. The load center of claim 3, wherein the controls are configured to synchronize a voltage and a frequency of a backup power system to that of the grid and reconnect a facility to the grid with no interruption in power to the facility.

12. The load center of claim 11, wherein the controls are configured to reconnect the facility to the grid with a delayed response based on at least one of external signals from a utility or a customer preference.

13. The load center of claim 3, wherein the controls are configured to derive control power from at least one of the grid, a power distribution system within a facility, or from separate low voltage control power distribution wiring.

14. A microgrid, comprising:
a distributed energy resource (DER) connected to at least one of a load or an energy storage device, the distributed energy resource (DER) comprises at least one renewable energy source (RES);
a DER controller operably coupled to the distributed energy resource for control thereof; and
a load center connected to the DER, the at least one of the load or the energy storage device, and the DER controller and comprising:
a main panel board configured to connect to a meter of the microgrid that measures energy consumed by the microgrid; and
a microgrid interconnect device disposed on the main panel board and configured to connect or disconnect the microgrid to/from a grid.

15. The microgrid of claim 14, wherein the microgrid interconnect device (MID) is configured to connect or disconnect the microgrid to/from the grid without having to collocate the microgrid interconnect device (MID) at the meter.

16. The microgrid of claim 14, wherein the microgrid interconnect device (MID) comprises controls and is mounted within the main panel board.

17. The microgrid of claim 16, wherein the controls are configured to monitor at least one of a voltage and a frequency of the grid or current flow to the grid.

18. The microgrid of claim 16, wherein the controls are configured to monitor at least one of a voltage and a frequency of a facility or current flow to the facility.

19. The microgrid of claim 16, wherein the controls are configured to autonomously isolate a facility from the grid when a grid voltage and frequency deviates from predetermined values.

20. The microgrid of claim 16, wherein the controls are configured to autonomously isolate a facility from the grid based on at least one of external signals from a utility, a third party aggregator, or customer preference.
